(19) United States
(12) Patent Application Publication
(10) Pub. No.: US 2006/0134555 A1
(43) Pub. Date: Jun. 22, 2006

(54) Monolithic inkjet printhead and method of manufacturing the same

(76) Inventors: Byung-ha Park, Suwon-si (KR); Myong-jong Kwon, Suwon-si (KR); Young-ung Ha, Suwon-si (KR)

Correspondence Address: STANZIONE & KIM, LLP, 919 18TH STREET, N.W., SUITE 440, WASHINGTON, DC, 20006, US

(21) Appl. No.: 11/283,822

(22) Filed: Nov. 22, 2005

(30) Foreign Application Priority Data
Dec. 3, 2004 (KR) 2004-101434

(51) Int. Cl. G03C 5/00

(52) U.S. Cl. 430/311

(57) ABSTRACT

A method of manufacturing an inkjet printhead includes forming a first photoresist layer on a substrate having ink ejection devices disposed thereon by coating the substrate with a first negative photoresist, exposing the first photoresist layer through a first photomask formed that defines a pattern of ink chambers, forming a second photoresist layer on the first photoresist layer by coating the first photoresist layer with a second negative photoresist, exposing the second photoresist layer through a second photomask that defines a pattern of nozzles, forming a nozzle layer having the nozzles by developing the second photoresist layer, forming the ink chambers by developing the first photoresist layer through the nozzles, and forming an ink supply path by etching a lower surface of the substrate. Thus, an inkjet printhead and a method of manufacturing the same are provided, where the manufacturing process is simple, and it is easy to control ink chambers and an ink flow path to have desired sizes and/or uniform sizes.

### CROSS-REFERENCE TO RELATED APPLICATIONS

This application claims the benefit of Korean Patent Application No. 2004-101434, filed on Dec. 3, 2004, in the Korean Intellectual Property Office, the disclosure of which is incorporated herein in its entirety by reference.

### BACKGROUND OF THE INVENTION

1. Field of the Invention

The present general inventive concept relates to a monolithic inkjet printhead and a method of manufacturing the same, and more particularly, to a monolithic inkjet printhead manufactured by a photolithographic process using a photoresist and a method of manufacturing the monolithic inkjet printhead by the photolithographic process.

2. Description of the Related Art

Generally, an inkjet printhead used in an inkjet printer ejects tiny droplets of ink onto a paper to form printed images. The inkjet printhead comprises ink chambers formed with an ink flow path extending therefrom, nozzles for ejecting droplets of ink from the ink chambers, and ink ejection devices for ejecting the droplets of ink. The ink ejection devices are energy generating devices such as electro-thermal conversion devices or piezoelectric devices.

A conventional method of manufacturing the monolithic inkjet printhead includes two methods that are called “PR (photoresist) Mold Process” and “PR (photoresist) Fill-up Process.” FIGS. 1A, 1B, and 1C illustrate the PR Mold Process and FIGS. 2A, 2B, and 2C illustrate the PR Fill-up Process.

According to the PR Mold Process, as illustrated in FIG. 1A, a photoresist is coated on a silicon substrate 10 having a pair of rows of ink ejection devices 11 disposed thereon. The photoresist is then pattern-exposed through a mask (not shown) and is developed using a solvent to form an ink flow pattern 12 (i.e., a PR Mold), which can be removed during a subsequent step.

As illustrated in FIG. 1B, an epoxy resin is then coated on both the substrate 10 and the ink flow pattern 12 to form a photosensitive coating layer 13 using a spin coating process. The photosensitive coating layer 13 is subsequently pattern-exposed and developed to form nozzles 14.

As illustrated in FIG. 1C, an ink supply path 15 is formed to extend through the substrate 10 by dry-etching the substrate 10 from a lower surface thereof using a photoresist pattern (not shown). Finally, the ink flow pattern 12 illustrated in FIGS. 1A and 1B is dissolved by dipping the substrate 10 in a solvent to form an ink flow path 16 including ink chambers to temporarily store ink.

According to the PR Fill-up Process, as illustrated in FIG. 2A, a photosensitive polymer layer 22 is formed on a silicon substrate 20 having a pair of rows of ink ejection devices 21 disposed thereon using a spin-coating process, and the photosensitive polymer layer 22 is pattern-exposed through a mask (not shown) and developed using a solvent to form an ink flow path 23 therebetween.

As illustrated in FIG. 2B, a photoresist 24 is then coated on the substrate 20 to fill the ink flow path 23 illustrated in FIG. 2A, and epoxy resin is spin-coated on both the photosensitive polymer layer 22 and the photoresist 24 to form a photosensitive coating layer 25. The photosensitive coating layer 25 is subsequently pattern-exposed and developed to form nozzles 26.

As illustrated in FIG. 2C, an ink supply path 27 is formed to extend through the substrate 20 by dry-etching the substrate 20 from a lower surface thereof using a photoresist pattern (not shown). Finally, the photoresist 24 is dissolved through the ink supply path 27 by dry etching to complete the PR Fill-Up Process.

However, regarding the PR Mold Process, the PR Mold (that is, the ink flow pattern 12 illustrated in FIGS. 1A and 1B) can be easily deformed during the process such that the photosensitive coating layer 13 coated on the ink flow pattern 12 ( illustrated in FIGS. 1B and 1C) may have a variation in thickness thereby making sizes of the ink flow path 16 (illustrated in FIG. 1C) and the ink chambers variable. Also, as illustrated in FIG. 1C, both end parts of the photosensitive coating layer 13 that are in contact with the substrate 10 are formed to be thick. As a result, cracks in the contact surface may develop if there is a residual stress between the photosensitive coating layer 13 and the substrate 10 during the manufacturing, process.

With regard to the PR Fill-up Process, an upper surface of the photosensitive polymer layer 22 may not be even with an upper surface of the photoresist 24 which is filled in the ink flow path 23 ( illustrated in FIGS. 2A and 2C). Thus, it is difficult to control sizes of the ink chamber and the ink flow path to be uniform using the photoresist 24.

The differences in sizes among the ink flow paths and the ink chambers decrease the overall performance of the inkjet printhead.

### SUMMARY OF THE INVENTION

The present general inventive concept provides an inkjet printhead and a method of manufacturing the same, where the manufacturing process is simple, and it is easy to control ink chambers and an ink flow path to have desired sizes and/or uniform sizes.

Additional aspects and/or advantages of the present general inventive concept will be set forth in part in the description which follows and, in part, will be obvious from the description, or may be learned by practice of the present general inventive concept.

The foregoing and/or other aspects and advantages of the present general inventive concept may be achieved by providing a method of manufacturing an inkjet printhead, the method comprising forming a first photoresist layer on a substrate having ink ejection devices disposed thereon by coating the substrate with a first negative photoresist, exposing the first photoresist layer through a first photomask that defines a pattern of ink chambers, forming a second photoresist layer on the first photoresist layer by coating the first photoresist layer with a second negative photoresist, exposing the second photoresist layer through a second photomask that defines a pattern of nozzles, forming a nozzle layer having the nozzles by developing the second photoresist layer, forming the ink chambers by developing the first photoresist layer through the nozzles, and forming an ink supply path by etching a lower surface of the substrate.

At least one of the first negative photoresist and the second negative photoresist that form the first photoresist layer and the second photoresist layer, respectively, may comprise a rubber photoresist.

The rubber photoresist may comprise a hybrid photoresist including rubber and bisazide.

The first negative photoresist used to form the first photoresist layer may comprise at least one of an epoxy-based photoresist resin, a silicon-based photoresist resin, an acryl-based photoresist resin, and an imide-based photoresist resin.

The method of manufacturing an inkjet printhead may further comprise baking the substrate between the exposing of the first photoresist layer and the forming of the second photoresist layer.

The foregoing and/or other aspects of the present general inventive concept may also be achieved by providing a method of manufacturing an inkjet printhead, the method comprising forming a first photoresist layer on a substrate having one or more pressure generating elements disposed thereon and defining a first portion of the first photoresist layer to include an ink flow path and one or more ink chambers and a first remaining portion, forming a second photoresist layer on the first photoresist layer and defining a second portion of the second photoresist layer to include one or more nozzles to correspond to the one or more ink chambers and a second remaining portion, and removing the first and second portions of the first and second photoresist layers to form the ink flow path, the one or more ink chambers, and the one or more nozzles.

The method may further comprise forming an ink supply path to supply ink to the ink flow path by etching the substrate from a surface opposite the one or more pressure generating elements.

The second photoresist layer may be formed on the first photoresist layer without removing the first portion of the first photoresist layer.

The removing of the first and second portions of the first and second photoresist layers may comprise developing the second photoresist layer with a second developing agent, and developing the first photoresist layer with a first developing agent.

The forming of the second photoresist layer may further comprise forming the second photoresist layer of an opaque material.

The method may further comprise hardening at least one of the first photoresist layer and the second photoresist layer without baking by exposing the at least one of the first photoresist layer and the second photoresist layer.

At least one of the first and second photoresist layer may comprise a rubber photoresist.

The foregoing and/or other aspects of the present general inventive concept may also be achieved by manufacturing an inkjet printhead, comprising forming a first layer of an ink flow structure on a substrate, performing a first photolithographic operation on the first layer, forming a second layer of the ink flow structure on the first layer, performing a second photolithographic operation on the second layer, removing a portion of the second layer, and removing a portion of the first layer.

The first layer may comprise a chamber layer, and the second layer may comprise a nozzle layer.

At least one of the forming of the first layer and the forming of the second layer may comprise forming a rubber hybrid photoresist layer.

The method may further comprise hardening at least one of the first layer and the second layer by exposure.

The first photolithography operation may comprise creating a defining portion and a removal portion in the first layer, and the forming of the second layer may comprise forming the second layer of the ink flow structure using the defining portion and the removal portion of the first layer as a support for the second layer.

The foregoing and/or other aspects and advantages of the present general inventive concept may also be achieved by providing an inkjet printhead comprising a chamber wall to define ink chambers on a substrate having ink ejection devices disposed thereon, a nozzle plate having nozzles disposed above the ink chambers to eject ink droplets, wherein at least one of the chamber wall and the nozzle plate comprises a rubber photoresist.

The chamber wall may comprise at least one of an epoxy-based photoresist resin, a silicon-based photoresist resin, an acryl-based photoresist resin, and an imide-based photoresist resin.

The rubber photoresist may comprise an OMR-83 material.

The foregoing and/or other aspects of the present general inventive concept may also be achieved by providing an inkjet printhead, comprising one or more pressure generating elements disposed on a surface of a semi-processed substrate, a first photoresist layer disposed on the semi-processed substrate and comprising a first portion to correspond to an ink flow path and one or more ink chambers that correspond to the one or more pressure generating elements and a first remaining portion to correspond to a chamber wall to define the ink flow path and the one or more ink chambers, and a second photoresist layer disposed on the first portion and the first remaining portion of the first photoresist layer and comprising a second portion to correspond to one or more nozzles to correspond to the one or more ink chambers and a second remaining portion to define the one or more nozzles, wherein the second portion and the first portion are removable in order.

The first photoresist layer and the second photoresist layer may comprise a negative photoresist.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A through 1C and FIGS. 2A through 2C are cross-sectional views illustrating conventional methods of manufacturing an inkjet printhead.

FIG. 3 is a cross-sectional view of an inkjet printhead according to an embodiment of the present general inventive concept.

FIGS. 4A through 4I are sectional views illustrating a method of manufacturing the inkjet printhead of FIG. 3 according to an embodiment of the present general inventive concept.

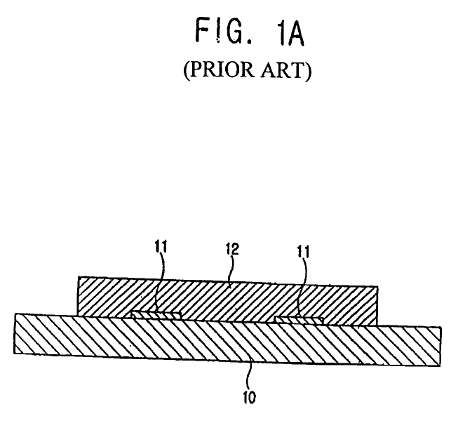

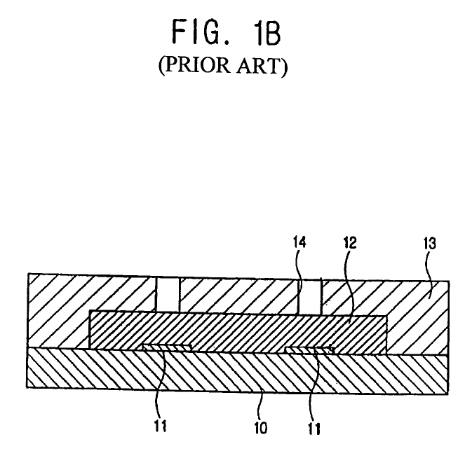

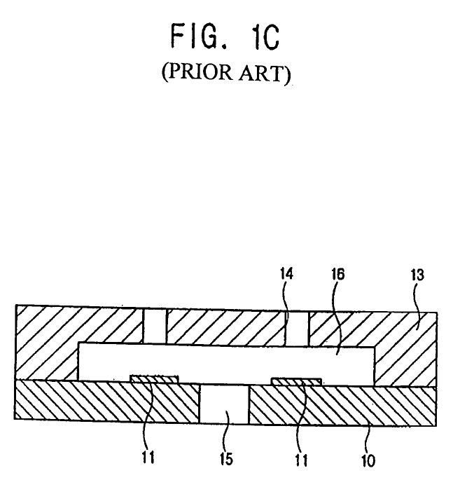

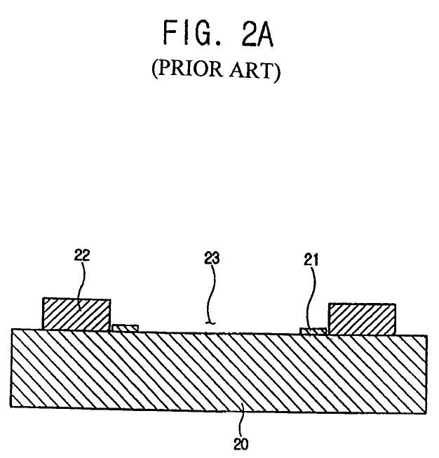

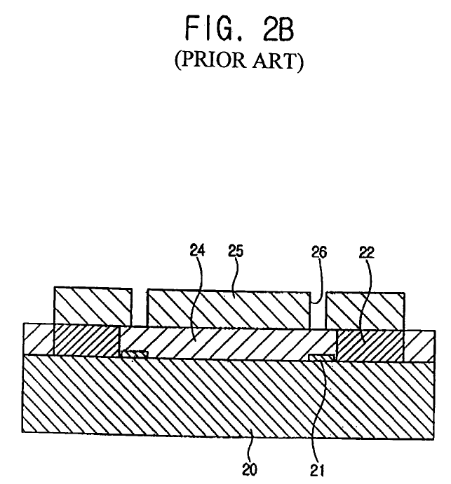

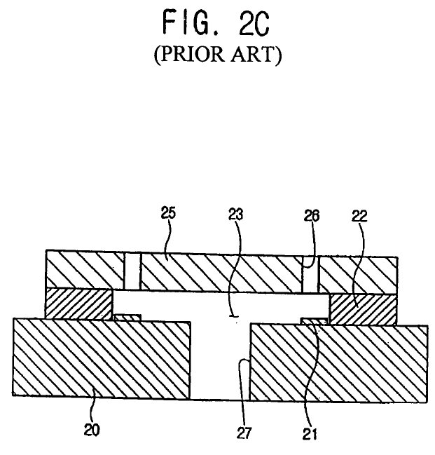

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout.

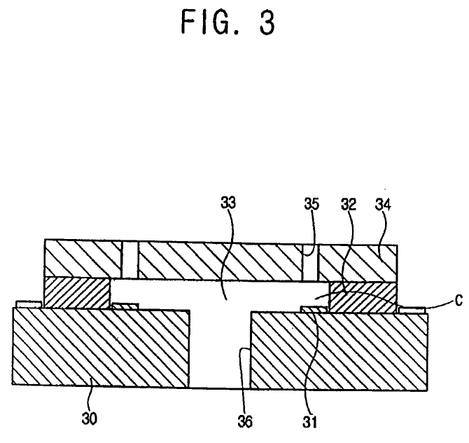

As illustrated in FIG. 3, an inkjet printhead according to an embodiment of the present general inventive concept comprises a substrate 30, a plurality of heaters 31 disposed on the substrate 30 in parallel with respect to each other, a chamber wall 32 to define ink chambers C having the heaters 31 disposed therein, and a nozzle plate 34 disposed on the chamber wall 32. An ink supply path 36 is formed to extend through the substrate 30 to supply ink to the ink chambers C. An ink flow path 33 is formed within the chamber wall 32 to connect the ink supply path 36 and the ink chambers C. Nozzles 35 are formed to extend through the nozzle plate 34 and are disposed above the ink chambers C. The heaters 31 are devices to generate energy to eject droplets of ink through the nozzles 35. Alternatively, piezoelectric devices can be used instead of the heaters 31 to eject the droplets of ink.

The chamber wall 32 is made of an epoxy resin. Alternatively, other photoresist materials such as a silicon resin, a polyacrylate resin, or a polyimide resin may also be used to form the chamber wall 32. The nozzle plate 34 is made of a rubber photoresist, which has rubber as an element. The rubber photoresist may be a hybrid photoresist comprising rubber and bisazide such as OMR-83, a product manufactured by Tokyo Ohka Kogyo Company.

With this configuration, ink supplied from an ink cartridge (not shown) flows through the ink supply path 36 and the ink flow path 33 into the ink chambers C. The ink that flows into the ink chambers C is then ejected out of the printhead through the nozzles 35 by an abrupt heat generated by the heaters 31. In particular, if the heaters 31 heat the ink in the ink chambers C, a bubble is generated in the ink. The bubble then pushes the ink in the ink chambers C out of the printhead through the nozzles 35.

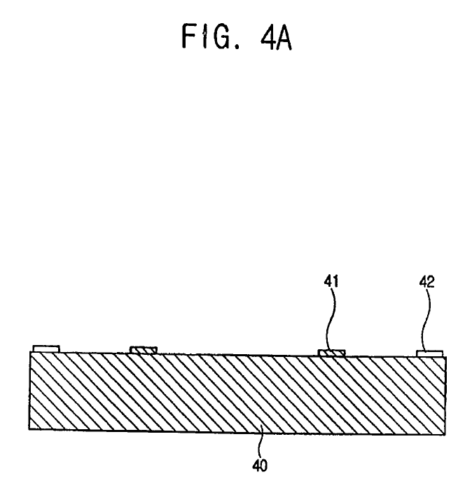

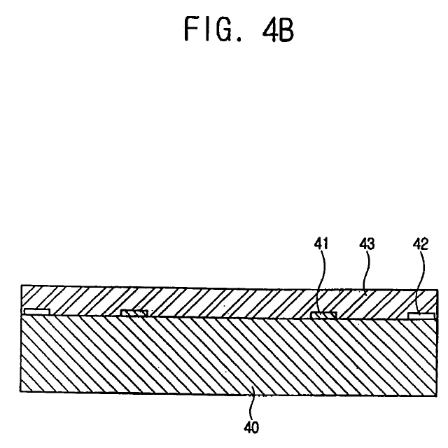

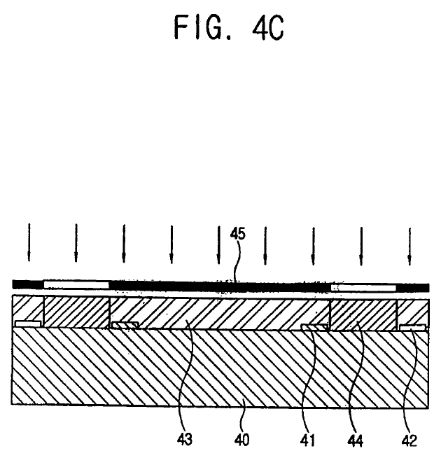

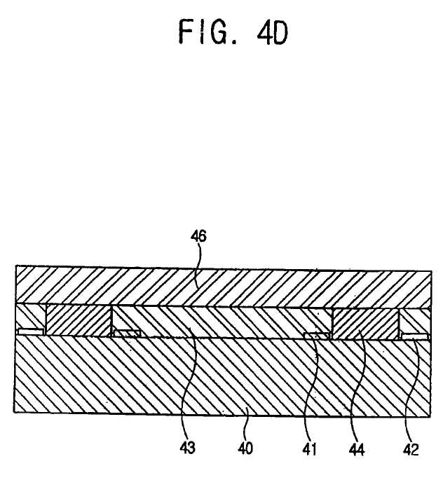

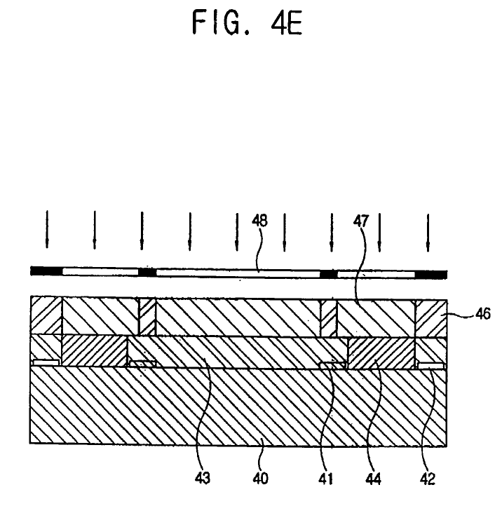

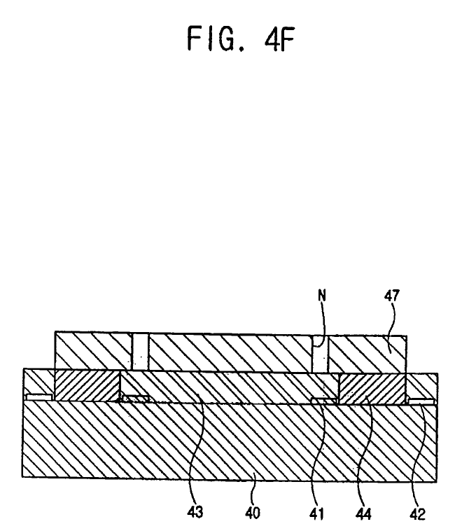

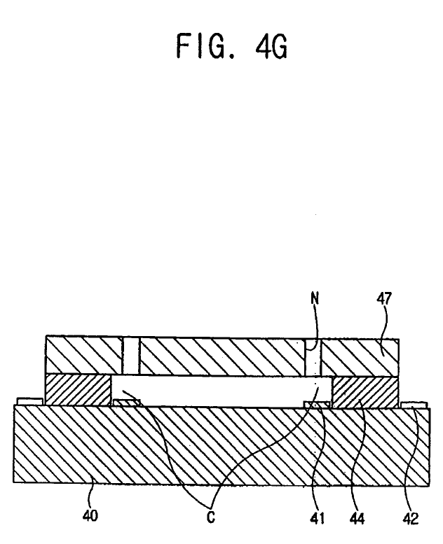

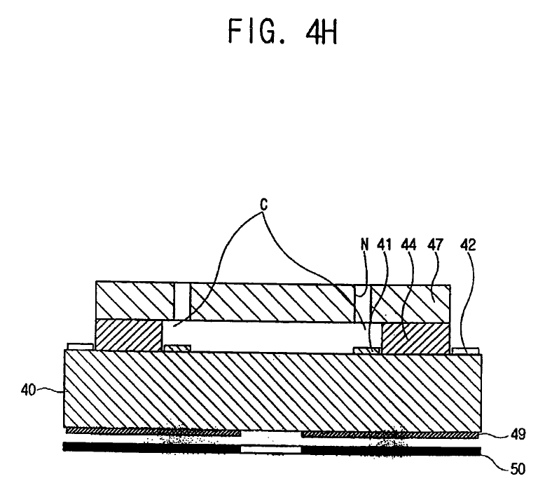

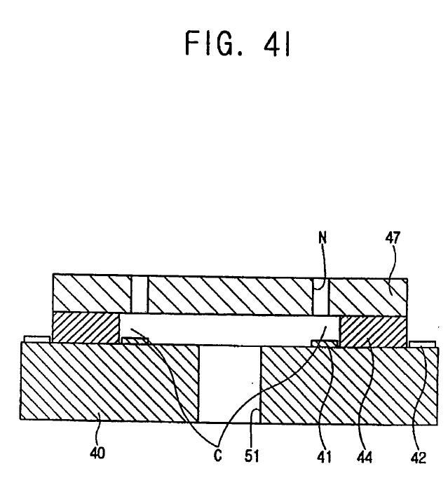

FIGS. 4A through 4I illustrate a method of manufacturing an inkjet printhead according to the embodiment of the present general inventive concept.

As illustrated in FIG. 4A, heaters 41 to heat ink in ink chambers (not shown) and electrodes 42 to supply electric current to the heaters 41 are formed on a substrate 40. The heaters 41 and the electrodes 42 may be made of a heat generating resistant material (e.g., tantalium nitride) and an aluminum or aluminum alloy electrically connected to the resistant material, respectively. A sputtering or chemical vapor deposition (CVD) method may be applied to form the heaters 41 and the electrodes 42. As illustrated in FIG. 4B, a negative photoresist may be coated onto the substrate 40 having the heaters 41 and the electrodes 42 to form a first photoresist layer 43. An epoxy-based photoresist resin may be used as the negative photoresist. Alternatively, other resins, such as a silicon-based photoresist resin, an acryl-based photoresist resin, and an imide-based photoresist resin, may also be used as the negative photoresist.

As illustrated in FIG. 4C, a first photomask 45 defining a pattern of an ink flow path and ink chambers is positioned over the first photoresist layer 43 disposed on the substrate 40. The first photoresist layer 43 is pattern-exposed to ultraviolet (UV) radiation through the first photomask 45. A part of the first photoresist layer 43 that is exposed to the UV radiation is hardened to form a chamber wall 44 having a high rigidity and a high resistance against chemicals. The other part of the first photoresist layer 43 that is not exposed to the UV radiation is removed by a subsequent developing process.

Once the first photoresist layer 43 is pattern-exposed, the first photoresist layer 43 is baked to activate chemical reactions in the chamber wall 44 that is exposed to the UV radiation and to make the chamber wall 44 firmly adhere to the substrate 40.

As illustrated in FIG. 4D, a negative photoresist may then be coated on the first photoresist layer 43 to form a second photoresist layer 46 without removing the other part of the photoresist layer 43 that is not exposed to the UV radiation. The negative photoresist that forms the second photoresist layer 46 can be hardened by simply exposing a part of the second photoresist layer 46. In other words, no baking is required. The rubber photoresist having rubber as an element (e.g., a hybrid photoresist comprising rubber and bisazide such as OMR-83, a product manufactured by Tokyo Ohka Kogyo Company) is a photoresist that hardens when it is exposed.

As illustrated in FIG. 4E, the second photoresist layer 46 is pattern-exposed to UV radiation through a second photomask 48, which defines a pattern of nozzles to form a nozzle layer 47. If the second photoresist layer 46 is composed of a transparent material, the UV radiation may penetrate the second photoresist layer 46 and influence the first photoresist layer 43. Thus, it is desirable that the second photoresist layer 46 be composed of an opaque material.

As illustrated in FIG. 4F, once the second photoresist layer 46 is pattern-exposed, the second photoresist layer 46 is developed by a developing agent to form nozzles N. As illustrated in FIG. 4G, the first photoresist layer 43 is then developed to form the ink chambers C and the ink flow path 33 of FIG. 3.

As illustrated in FIG. 4H, a third photoresist layer 49 is then coated on a lower surface of the substrate 40 and is pattern-exposed to UV radiation through a third photomask 50, which defines a pattern of an ink supply path 51.

The substrate 40 is then dry etched or wet etched through the third photoresist layer 49 to form the ink supply path 51. The third photoresist layer 49 is then developed and removed by the developing agent to complete the method of manufacturing an inkjet printhead.

The rubber photoresist may be used as the negative photoresist to form both the first photoresist layer 43 and the second photoresist layer 46. In this case, the first photoresist layer 43 can be hardened by simply exposing the first photoresist layer 43, thus making a baking process unnecessary. Additionally, although the method of manufacturing the inkjet printhead of the present general inventive concept is described with reference to a negative photoresist, other photoresists that achieve the desired purpose may alternatively be used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing an inkjet printhead, the method comprising:
forming a first photoresist layer on a substrate having ink ejection devices disposed thereon by coating the substrate with a first negative photoresist;
exposing the first photoresist layer through a first photomask formed that defines a pattern of ink chambers;
forming a second photoresist layer on the first photoresist layer by coating the first photoresist layer with a second negative photoresist;
exposing the second photoresist layer through a second photomask that defines a pattern of nozzles;
forming a nozzle layer having the nozzles by developing the second photoresist layer;
forming the ink chambers by developing the first photoresist layer through the nozzles; and
forming an ink supply path by etching a lower surface of the substrate.

2. The method of manufacturing the inkjet printhead according to claim 1, wherein at least one of the first and second negative photoresists used to form the first photoresist layer and the second photoresist layer, respectively, comprises a rubber photoresist.

3. The method of manufacturing the inkjet printhead according to claim 2, wherein the rubber photoresist comprises a hybrid photoresist including rubber and bisazide.

4. The method of manufacturing the inkjet printhead according to claim 1, wherein the first negative photoresist used to form the first photoresist layer comprises at least one of an epoxy-based photoresist resin, a silicon-based photoresist resin, an acryl-based photoresist resin, and an imide-based photoresist resin.

5. The method of manufacturing the inkjet printhead according to claim 2, wherein the first negative photoresist used to form the first photoresist layer comprises at least one of an epoxy-based photoresist resin, a silicon-based photoresist resin, an acryl-based photoresist resin, and an imide-based photoresist resin.

6. The method of manufacturing the inkjet printhead according to claim 3, wherein the first negative photoresist used to form the first photoresist layer comprises at least one of an epoxy-based photoresist resin, a silicon-based photoresist resin, an acryl-based photoresist resin, and an imide-based photoresist resin.

7. The method of manufacturing the inkjet printhead according to claim 4, further comprising:
baking the substrate between the exposing of the first photoresist layer and the forming of the second photoresist layer.

8. The method of manufacturing the inkjet printhead according to claim 5, further comprising:
baking the substrate between the exposing of the first photoresist layer and the forming of the second photoresist layer.

9. The method of manufacturing the inkjet printhead according to claim 6, further comprising:
baking the substrate between the exposing of the first photoresist layer and the forming of the second photoresist layer.

10. A method of manufacturing an inkjet printhead, the method comprising:
forming a first photoresist layer on a substrate having one or more pressure generating elements disposed thereon and defining a first portion of the first photoresist layer to include an ink flow path and one or more ink chambers and a first remaining portion;
forming a second photoresist layer on the first photoresist layer and defining a second portion of the second photoresist layer to include one or more nozzles to correspond to the one or more ink chambers and a second remaining portion; and
removing the first and second portions of the first and second photoresist layers to form the ink flow path, the one or more ink chambers, and the one or more nozzles.

11. The method according to claim 10, further comprising:
forming an ink supply path to supply ink to the ink flow path by etching the substrate from a surface opposite the one or more pressure generating elements.

12. The method according to claim 10, wherein the second photoresist layer is formed on the first photoresist layer without removing the first portion of the first photoresist layer.

13. The method according to claim 10, wherein the removing of the first and second portions of the first and second photoresist layers comprises:
developing the second photoresist layer with a second developing agent; and
developing the first photoresist layer with a first developing agent.

14. The method according to claim 10, wherein the forming of the second photoresist layer further comprises forming the second photoresist layer of an opaque material.

15. The method according to claim 10, further comprising:
hardening at least one of the first photoresist layer and the second photoresist layer without baking by exposing the at least one of the first photoresist layer and the second photoresist layer.

16. The method according to claim 10, wherein at least one of the first and second photoresist layer comprises a rubber photoresist.

17. A method of manufacturing an inkjet printhead, the method comprising:
forming a first layer of an ink flow structure on a substrate;
performing a first photolithographic operation on the first layer;
forming a second layer of the ink flow structure on the first layer;
performing a second photolithographic operation on the second layer;
removing a portion of the second layer; and
removing a portion of the first layer.

18. The method according to claim 17, wherein the first layer comprises a chamber layer, and the second layer comprises a nozzle layer.

19. The method according to claim 17, wherein at least one of the forming of the first layer and the forming of the second layer comprises forming a rubber hybrid photoresist layer.

20. The method according to claim 17, further comprising:
hardening at least one of the first layer and the second layer by exposure.

21. The method according to claim 17, wherein:
the first photolithography operation comprises creating a defining portion and a removal portion in the first layer; and
the forming of the second layer comprises forming the second layer of the ink flow structure using the defining portion and the removal portion of the first layer as a support for the second layer.

22. An inkjet printhead comprising:
a chamber wall to define ink chambers on a substrate having ink ejection devices disposed thereon; and
a nozzle plate having nozzles disposed above the ink chambers to eject ink droplets, wherein at least one of the chamber wall and the nozzle plate comprises a rubber photoresist.

23. The inkjet printhead according to claim 22, wherein the chamber wall comprises at least one of an epoxy-based photoresist resin, a silicon-based photoresist resin, an acryl-based photoresist resin, and an imide-based photoresist resin.

24. The inkjet printhead according to claim 22, wherein the rubber photoresist comprises an OMR-83 material.

25. An inkjet printhead, comprising:
one or more pressure generating elements disposed on a surface of a semi-processed substrate;
a first photoresist layer disposed on the semi-processed substrate and comprising a first portion to correspond to an ink flow path and one or more ink chambers that correspond to the one or more pressure generating elements and a first remaining portion to correspond to a chamber wall to define the ink flow path and the one or more ink chambers; and
a second photoresist layer disposed on the first portion and the first remaining portion of the first photoresist layer and comprising a second portion to correspond to one or more nozzles to correspond to the one or more ink chambers and a second remaining portion to define the one or more nozzles,
wherein the second portion and the first portion are removable in order.

26. The inkjet printhead according to claim 25, wherein the first photoresist layer and the second photoresist layer comprise a negative photoresist.
